(19) United States
(12) Patent Application Publication
(10) Pub. No.: US 2011/0107084 A1
(43) Pub. Date: May 5, 2011

(54) SYSTEM FOR AND METHOD FOR RELAYING MESSAGES

(75) Inventors: Paul V. Hubner, McKinney, TX (US); Kristopher A. Pate, Sache, TX (US); Steven T. Archer, Dallas, TX (US); Robert A. Clavenna, Lucas, TX (US); Gary L. Campbell, Allen, TX (US)

(73) Assignee: VERIZON PATENT AND LICENSING, INC., Basking Ridge, NJ (US)

(21) Appl. No.: 12/612,765

(22) Filed: Nov. 5, 2009

(51) Int. Cl. H04L 29/06; H04B 7/14

(52) U.S. Cl. 713/153; 370/315

(57) ABSTRACT

A system for and method of relaying messages is presented. In an exemplary embodiment, the system and method may include receiving a request from a user to transmit a message to an intended recipient, processing the message for transmission, wherein processing the message comprises assigning metadata to the message, and transmitting the message with the metadata to the intended recipient, where transmitting the message with metadata comprises searching for at least one proximate ad hoc relay device in the event that a communication link cannot be established with a communication network.

### BACKGROUND INFORMATION

Wireless networks have become increasingly popular for providing network access to a mobile user device to transmit messages. Wireless networks allow connectivity of mobile user devices to networked resources while reducing the need for traditional hard-wired network access. As a result, wireless networks provide a user with greater flexibility and convenience. For example, wireless networks allow for the mobility of a mobile user device within the coverage range of the wireless networks. However, wireless networks may be unavailable due to limited coverage range or network capacity, severe weather, or power outage. Messages (e.g., 911 emergency messages or messages to loved ones) transmitted by the mobile user device when the wireless networks are unavailable may not be delivered.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system for relaying messages according to a particular embodiment;

FIG. 2 is a block diagram of a hardware component of the mobile user device according to a particular embodiment;

FIG. 3 illustrates a schematic diagram illustrating a system for relaying messages in the event that a mobile user device cannot establish a communication link with a communication network according to a particular embodiment; and

FIG. 4 is a flowchart illustrating the functionality of relaying messages associated with a mobile user device according to a particular embodiment.

FIG. 5 is a flowchart illustrating the functionality of relaying messages associated with an ad hoc relay device according to a particular embodiment.

FIG. 6 is a flowchart illustrating the functionality of relaying messages associated with a message relay system according to a particular embodiment.

### DETAILED DESCRIPTION OF PREFERRED EMBODIMENTS

An exemplary embodiment provides a system and a process for relaying messages via an ad hoc network. For example, a plurality of ad hoc relay devices (e.g., various mobile user devices) may form an ad hoc network. In an exemplary embodiment, a first mobile user device may not be positioned within a service coverage area of a wireless network provided by a service provider. The first mobile user device may seek to establish a wireless communication link with one or more other mobile user devices. The first mobile user device may transmit one or more messages to the other mobile user devices via an established wireless communication link (e.g., Bluetooth, Wi-Fi, ultra wide band (UWB), white spaces transmission, or other radio frequency communication links). The other mobile user devices may receive the messages from the first mobile user device via the wireless communication link and may become an ad hoc relay device. The ad hoc relay device may move back into a service coverage area of a wireless network provided by a service provider. The ad hoc relay device may transmit the messages from the first mobile user device to a message relay system associated with a service provider. The message relay system associated with a service provider may transmit the messages from the first mobile user device to a message delivery system to be delivered to an intended recipient.

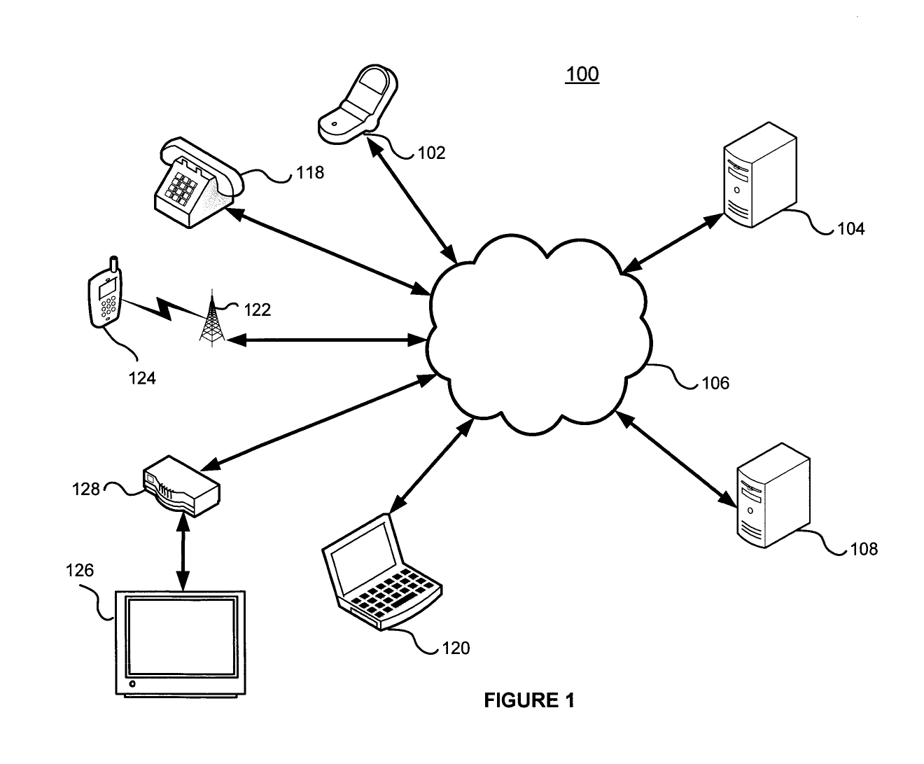

FIG. 1 is a schematic diagram illustrating a system for relaying messages according to particular embodiments. As illustrated in FIG. 1, system 100 may include a mobile user device 102 associated with a first user which may interact with a message relay system 104 via a communication network 106. The mobile user device 102 may also interact with a message delivery system 108 via a communication network 106. As illustrated, the communication network 106 may be communicatively coupled with at least one other mobile user devices associated with other users including a telephone 118 or a computer 120. Other mobile user devices associated with other users may communicate with the communication network 106 via one or more intermediary devices, such as a transmitter/receiver 122 or a set-top box 128. For example, a wireless mobile user device 124 may communicate with the communication network 106 via the transmitter/receiver 122. Also, a television 126 may communicate with the communication network 106 via the set-top box 128. In an exemplary embodiment, a first user associated with the mobile user device 102 may be located outside of a service coverage area of the communication network 106 or a communication link may not be established with the communication network 106 (e.g., system outage, severe weather, outside of service coverage range, or limited network infrastructure). The first user associated with the mobile user device 102 may transmit one or more messages to other mobile user devices including at least one of the telephone 118, the computer 120, the wireless device 124, and the television 126 to communicate with the message relay system 104 and the message delivery system 108. The one or more other mobile user devices may become an ad hoc relay device for transmitting the messages from the first user to the message relay system 104 and the message delivery system 108. The message relay system 104 and the message delivery system 108 may transmit the messages from the first user to one or more intended recipients.

The mobile user devices 102 may be a computer, a personal computer, a laptop, a cellular communication device, a workstation, a mobile device, a phone, a handheld PC, a personal digital assistant (“PDA”), a thin system, a fat system, a network appliance, an Internet browser, or other any other device that may allow a user to communicate with the message relay system 104 and the message delivery system 108 via the communication network 106. A first user associated with the mobile user device 102 may transmit one or more messages to the message relay system 104 and the message delivery system 108 via the communication network 106 to deliver the transmitted messages to an intended recipient.

The message relay system 104 may include one or more servers. For example, the message relay system 104 may include a UNIX based server, Windows 2000 Server, Microsoft IIS server, Apache HTTP server, API server, Java sever, Java Servlet API server, ASP server, PHP server, HTTP server, Mac OS X server, Oracle server, IP server, or other independent server to relay one or more transmitted messages from a first user to an intended recipient. The message relay system 104 may include one or more databases.

The communication network 106 may be coupled to the message relay system 104 and the message delivery system 108. The communication network 106 may be a wireless network, a wired network or any combination of wireless network and wired network. For example, the communication network 106 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and receiving a data signal. In addition, the communication network 106 may include, without limitation, telephone line, fiber optics, IEEE Ethernet 802.3, wide area network (“WAN”), local area network (“LAN”), or global network such as the Internet. The communication network 106 may support an Internet network, a wireless communication network, a cellular network, or the like, or any combination thereof. The communication network 106 may further include one, or any number of the exemplary types of networks mentioned above operating as a stand-alone network or in cooperation with each other.

The communication network 106 may utilize one or more protocols of one or more network elements to which it is communicatively coupled. The communication network 106 may translate to or from other protocols to one or more protocols of network devices. Although the communication network 106 is depicted as one network, it should be appreciated that according to one or more embodiments, the communication network 106 may comprise a plurality of interconnected networks, such as, for example, a service provider network, the Internet, a broadcaster's network, a cable television network, corporate networks, and home networks.

The message delivery system 108 may include one or more servers. For example, the message delivery system 108 may include a UNIX based server, Windows 2000 Server, Microsoft IIS server, Apache HTTP server, API server, Java sever, Java Servlet API server, ASP server, PHP server, HTTP server, Mac OS X server, Oracle server, IP server, or other independent server to establish a communication session between first user and second user. Also, the message delivery system 108 may include one or more Internet Protocol (IP) network server or public switch telephone network (PS TN) server.

The transmitter/receiver 122 coupling the wireless device 124 to the communication network 106 may be a repeater, a microwave antenna, a cellular tower, or another network access device capable of providing connectivity between two different network mediums. Transmitter/receiver 122 may be capable of sending and receiving signals via a mobile network, a paging network, a cellular network, a satellite network or a radio network. Transmitter/receiver 122 may provide connectivity to one or more wired networks and may be capable of receiving signals on one medium such as a wired network and transmitting the received signals on a second medium such as a wireless network.

The set-top box 128 may be an integrated receiver/decoder (IRD) device or a small computer that may communicatively couple the television 126 to the communication network 106. The set-top box 128 may receive and process an external signal and couple the external signal to the television 126 and the communication network 106. For example, the set-top box 128 may receive one or more messages transmitted by the mobile user device 102 and relay the one or more messages transmitted by the mobile user device 102 to the communication network 106. In an exemplary embodiment, the set-top box 127 may be communicatively coupled to, integrated, or associated with the television 126. The set-top box 128 may be a digital video recorder, a converter, a transceiver, or other device capable of receiving and transmitting external signals. The set-top box 128 may communicatively couple an external signal source from an Ethernet cable, a satellite dish, a coaxial cable, a telephone line, a broadband over power line, an antenna, a wireless transmission coupler or other external signal source to transmit an external signal to the set-top box 128.

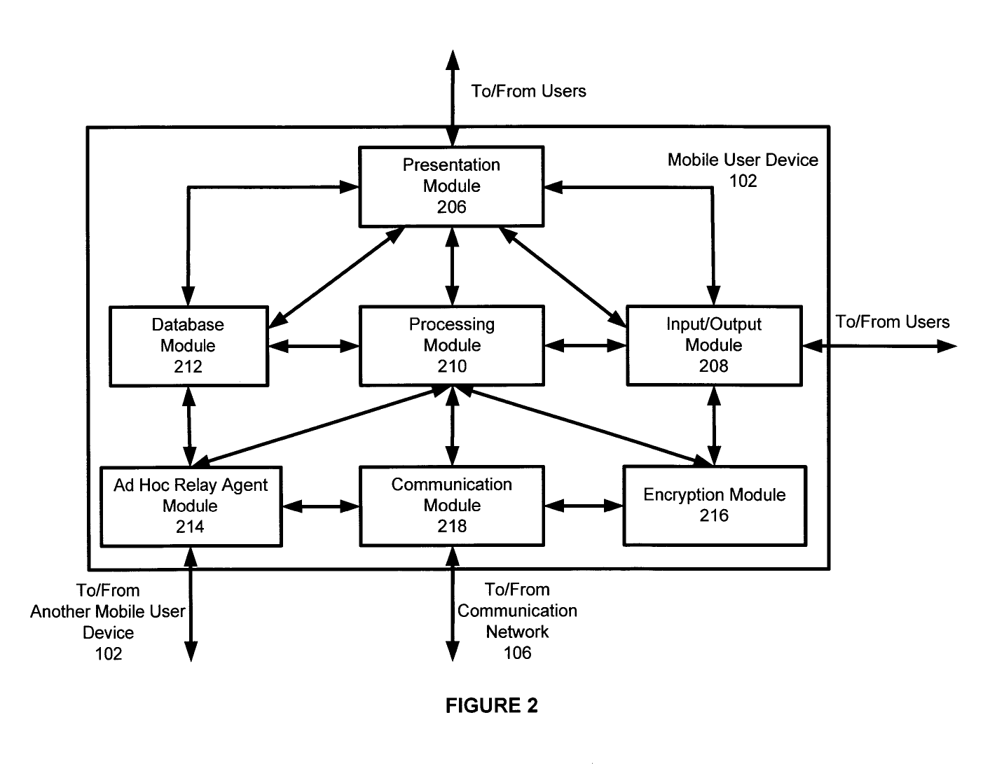

FIG. 2 is a block diagram of a hardware component of the mobile user device according to a particular embodiment. The mobile user device 102 may include a presentation module 206, an input/output module 208, a processing module 210, a database module 212, an ad hoc relay agent module 214, an encryption module 216, or a communication module 218. It is noted that the modules 206, 208, 210, 212, 214, 216, and 218 are exemplary and the functions performed by one or more of the modules may be combined with that performed by other modules. The functions described herein as being performed by the modules 206, 208, 210, 212, 214, 216, and 218 also may be separated and may be located or performed by other modules. Moreover, the modules 206, 208, 210, 212, 214, 216, and 218 may be implemented at other devices of the system 100 (e.g., the telephone 118, the computer 120, the transmitter/receiver 122, the wireless mobile user device 124, the television 126, or the set-top box 128).

The presentation module 206 may provide an interface between the mobile user device 102 and a user associated with the mobile user device 102. The presentation module 206 may include a user interface, e.g., a graphical user interface, an application programming interface (API) to interact with the users associated with the mobile user device 102. The presentation module 206 may receive one or more queries or requests from a user and to provide the received queries or requests to other modules of the mobile user device 102. The presentation module 206 may provide queries or requests to the processing module 210, wherein the queries or requests may determine an operation of the processing module 210. In response to receiving a query or request from a user, the presentation module 206 may provide the queries or requests (e.g., control signals, etc.) to the input/output module 208, the processing module 210, the database module 212, the ad hoc relay agent module 214, the encryption module 216, and communication module 218. In an exemplary embodiment, the user may request that the mobile user device 102 transmit one or more messages via an ad hoc relay device to the communication network 106 in the event that the mobile user device 102 does not have a communication link with the communication network 106.

The presentation module 206 may present information or data to the user via a display of the mobile user device 102. The presentation module 206 may display upon a user's device a query or request, or the presentation module 206 may automatically display information or data to the user. In an exemplary embodiment, the presentation module 206 may provide information or data to indicate whether the mobile user device 102 has a communication link with the communication network 106. For example, the presentation module 206 may provide information or data to inform the user that the mobile user device 102 is not within a service coverage range of the communication network 106. In another exemplary embodiment, the presentation module 206 may provide information or data to indicate one or more operations performed by the mobile user device 102. For example, the presentation module 206 may provide a message (e.g., “SENT”) to inform the user that the mobile user device 102 has transmitted one or more messages per user's request. The presentation module 206 may provide information or data to inform the user that one or more operations may not be completed and an alternative operation may be performed. For example, the presentation module 206 may notify the user that one or more messages were not successfully sent (e.g., “ERROR”) and the mobile user device 102 will attempt to transmit the messages via an ad hoc relay device. In other exemplary embodiments, the presentation module 206 may provide information or data to solicit a response from the user. For example, the presentation module 206 may solicit a response from the user to determine whether to transmit one or more messages via an ad hoc relay device in the event that a communication link is not available between the mobile user device 102 and the communication network 106.

The input/output module 208 may include manual input (e.g., typing into a keyboard or keypad, etc.), voice input, touch screen input, graphical input (e.g., camera or camcorder) and/or any other method for inputting information or data. In an exemplary embodiment, the input/output module 208 may include manual inputs having one or more keyboards and/or key pad for inputting information. Also, the input module 208 may include a DTMF signal generator having DTMF keys to generate numerical signals and text signals. In an exemplary embodiment, a user associated with the mobile user device 102 may input a text message via the input/output module 208 to be transmitted to an intended recipient. The user associated with the mobile user device 102 may input a voice message or a video message via the input/output module 208 to be transmitted to an intended recipient.

The input/output module 208 may preprocess (e.g., filter, sort, format, and aggregate) the messages inputted by the user before transferring the messages to the processing module 210. In an exemplary embodiment, the preprocessing of the messages performed by the input/output module 208 may include filtering the messages and eliminating erroneous or defective messages, sorting the messages in accordance with the priority or intended recipient, converting the messages into desired format (e.g., convert analog signals to digital signals), and formatting the messages for transmission (e.g., format the messages according to desired protocols for transmission).

The processing module 210 may include one or more processors to control operations performed by the various modules of the mobile user device 102. The processing module 210 may be in communication with the presentation module 206, the input/output module 208, the database module 212, the ad hoc relay agent module 214, the encryption module 216, and the communication module 218. The processing module 210 may further include a plurality of sub-analytical modules to enable transmission of one or more messages to an intended recipient from the mobile user device 102. In an exemplary embodiment, the processing module 210 may receive one or more queries or requests from users via the presentation module 206 or one or more messages from the users via the input/output module 208. For example, the processing module 210 may receive a request or query to transmit a message received from the input/output module 208 in the event that the mobile user device 102 may not be within a service coverage area of the communication network 106.

The processing module 210 may determine a status of the mobile user device 102. In an exemplary embodiment, the processing module 210 may determine whether a communication link may be established between the mobile user device 102 and the communication network 106. For example, the communication module 218 may establish a communication link with the communication network 106, and the processing module 210 may access the communication module 218 in order to determine whether a communication link is established between the mobile user device 102 and the communication network 106. In an exemplary embodiment, the processing module 210 may determine that a communication link is established between the mobile user device 102 and the communication network 106, the processing module 210 may access the database module 212. The processing module 210 may access the database module 212 to determine whether one or more messages stored in the database module 212 need to be transmitted to the message relay system 104 and the message delivery system 108 via the communication network 106. When one or more messages stored in the database module 212 need to be transmitted to the message relay system 104 and the message delivery system 108, the processing module 210 may instruct the communication module 218 to transmit the messages to the message relay system 104 and the message delivery system 108.

The processing module 210 may generate a hash file associated with the messages received from the input/output module 208. The hash file may be transmitted along with the messages as part of metadata associated with the messages. For example, a hash file may be a function associated with the messages in order to provide record identification for the message relay system 104. In an exemplary embodiment, a hash file may be a one-way numerical reduction of the messages into a statistically unique identifier in order to provide a record identification of the status of the messages. The hash file may determine whether the messages received from the input/output module 208 are delivered to the message relay system 104 and subsequently delivered to the intended recipient via the message delivery system 108. The hash file generated by the processing module 210 may be associated with the messages received from the input/output module 208. For example, the hash file generated by the processing module 210 may not reveal the contents of the messages received from the input/output module 208. That is the contents of the messages received from the input/output module 208 may not be determined based on the hash file generated by the processing module 210.

The processing module 210 may generate and assign a max-hop counter to the messages received from the input/output module 208. For example, the max-hop counter may be a part of the metadata associated with the messages. The max-hop counter may be decremented each time the messages are relayed to an ad hoc relay device (e.g., the telephone 118, the computer 120, the transmitter/receiver 122, the wireless mobile user device 124, the television 126, or the set-top box 128). The processing module 210 may assign a predetermine number to the max-hop counter to indicate a number of times the messages may be relayed. The messages may be relayed via one or more ad hoc relay device until the max-hop counter reaches zero. In an exemplary embodiment, the max-hop counter may be a factorial counter (e.g., factorial of a non-negative integer n or product of all positive integers less than or equal to n). For example, the processing module 210 may assign a number five to the max-hop counter and the max-hop counter may be transmitted as part of the metadata associated with the messages. The messages may be relayed for 120 times (e.g., 1×2×3×4×5) via a plurality of ad hoc relay devices until the max-hop counter reaches zero.

The processing module 210 may assign a priority level to one or more messages (e.g., from highest to lowest “E”, “1,” “2,” “3,” “4,” and “5”). The processing module 210 may also determine a priority level of one or more received messages. In an exemplary embodiment, the processing module 210 may assign a priority level to one or more messages based at least in part on a user. A user associated with the mobile user device 102 may create a plurality of messages for a plurality of intended recipients. The user may assign a priority level associated with each of the plurality of intended recipients, and the processing module 210 may assign a priority level to the messages for each of the plurality of intended recipients according to the priority level assigned by the user to each of the plurality of intended recipients. For example, a user may assign a family member with the highest priority level (e.g., “E”), a friend with a priority level (e.g., “2”), a co-worker with a priority level (e.g., “4”). The processing module 210 may also assign a priority level (e.g., “E”) for messages intended for the family member, a priority level (e.g., “2”) for messages intended for the friend, and a priority level (e.g., “4”) for messages intended for the co-worker.

In another exemplary embodiment, the processing module 210 may assign a priority level to one or more messages based at least in part on a service provider. The service provider may assign a priority level based on the user's service subscription. The processing module 210 may assign a priority level to the messages transmitted by the user according to the priority level assigned by the service provider based on the user's service subscription. For example, a first user may subscribe to a service having a first priority level (e.g., “E”), a second user may subscribe to a service having a second priority level (e.g., “3”), and a third user may subscribe to a service having a third priority level (e.g., “5”). The processing module 210 of the mobile user device 102 associated with each user, may assign a priority level (e.g., “E”) to messages transmitted by the first user, a priority level (e.g., “3”) to messages transmitted by the second user, and a priority level (e.g., “5”) to messages transmitted by the third user. In other exemplary embodiments, the processing module 210 may assigned a priority level to one or more messages based at least in part on the intended recipient. For example, the processing module 210 may assign a priority level (e.g., “E”) to a message associated with an emergency (e.g., fire department, police, ambulance) and a priority level (e.g., “5”) to a message for chatting between friends.

The processing module 210 may add or associate metadata or metainformation to the messages received from the input/output module 208. For example, the metadata or metainformation may include, time stamps, location of the mobile user device 102, user identification and information, intended recipient identification and information, mobile user device identification information, hash file, max-hop counter, priority level, or other information or data associated with the messages. The metadata or metainformation may be transmitted along with the messages.

The processing module 210 may perform a data compression operation in order to reduce an amount of data for transmission and increase the transmission speed. For example, the processing module 210 may perform data compression operation using various algorithms including, lossless algorithms, Lempel-Ziv (LZ) compression algorithms, lossy data compression or perceptual coding, lossy image compression algorithms, lossy audio compression algorithms, other types of algorithms for compressed encoding information. The processing module 210 may also perform a data decompression operation upon reception of one or more messages.

The database module 212 may store and manage one or more messages. The database module 212 may provide an interface, e.g., a uniform interface, for other modules within the mobile user device 102 and may write, read, and search for messages stored in one or more repositories or databases. The database module 212 may also perform other functions, such as, but not limited to, concurrent access, backup and archive functions. Due to limited amount of storing space the database module 212 may compress, store, transfer or discard the messages stored within, after a period of time, e.g., a day. The database module 212 may store one or more messages from the processing module 210 for transmission at a later time in the event that the messages cannot be sent to the communication network 106 (e.g., system outage, severe weather, outside of service coverage range, or limited network infrastructure). The database module 212 may also provide one or more messages to the processing module 210 for transmission. In another exemplary embodiment, the database module 212 may store messages from another mobile user device 102. For example, the ad hoc relay agent module 214 may receive one or more messages from another mobile user device 102. The ad hoc relay agent module 214 may provide the messages from another mobile user device 102 to the database module 212 and store the messages.

The database module 212 may be network accessible storage and may be local, remote, or a combination thereof to modules 206, 208, 210, 214, 216, and 218. The database module 212 may utilize a flash memory, a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage.

The ad hoc relay agent module 214 may include one or more transceivers (e.g., Bluetooth, Wi-Fi, ultra wide band (UWB), white spaces radio frequency transmission, or other radio frequency systems) to receive one or more messages from another mobile user device 102 and transmit one or more messages to another mobile user device 102. The ad hoc relay agent module 214 may be controlled by a user associated with the mobile user device 102. For example, the user may provide a request to turn on or turn off the ad hoc relay agent module 214. The ad hoc relay agent module 214 may also be controlled by a service provider. For example, the service provider may turn on or turn off the ad hoc relay agent module 214 based on a subscription of services provided by the service provider.

In the event that the ad hoc relay agent module 214 is turned on, the ad hoc relay agent module 214 may seek one or more proximate mobile user devices 102 to establish a communication link. For example, the ad hoc relay agent module 214 may actively seek one or more proximate mobile user devices 102. In an exemplary embodiment, the ad hoc relay agent module 214 may be in a “transmission mode,” where the ad hoc relay agent module 214 may periodically transmit one or more ad hoc beacon signals to seek one or more proximate mobile user devices 102. The ad hoc relay agent module 214 may passively seek one or more proximate mobile user devices 102. In an exemplary embodiment, the ad hoc relay agent module 214 may be in a “reception mode,” where the ad hoc relay agent module 214 may detect one or more ad hoc beacon signals transmitted by another mobile user device 102.

The ad hoc relay agent module 214 may establish a communication link (e.g., Bluetooth, Wi-Fi or other radio frequency links) with one or more proximate mobile user device 102. The ad hoc relay agent module 214 may transmit one or more messages to the other proximate mobile user devices 102 in the event that the mobile user device 102 cannot establish a communication link with the communication network 106. The ad hoc relay agent module 214 may receive one or more messages from the other proximate mobile user devices 102 in the event that the other proximate mobile user devices 102 cannot establish a communication link with the communication network 106.

The encryption module 216 may encrypt the messages from the input/output module 208 or the processing module 210. For example, the encryption module 216 may encrypt the messages using public encryption key pairs, a private encryption key, Rijndael encryption, Serpent encryption, Twofish encryption, RC6 encryption, MARS encryption or other process or algorithms to encrypt the messages.

The communication module 218 may include one or more transceivers to establish a communication link with the communication network 106. The communication module 218 may automatically detect and establish a communication link with the communication network 106. The communication module 218 may inform the processing module 210 that the mobile user device 102 may have a communication link with the communication network 106. The communication module 218 may transmit one or more messages to the message relay system 104 and the message delivery system 108 via the communication network 106. In the event that the communication module 218 cannot establish a communication link with the communication network 106, the communication module 218 may inform the processing module 210 that the mobile user device 102 cannot establish a communication link with the communication network 106. The communication module 218 may periodically or continuously transmit network establishment signals to search for the communication network 106 until the communication link is reestablish between the mobile user device 102 and the communication network 106.

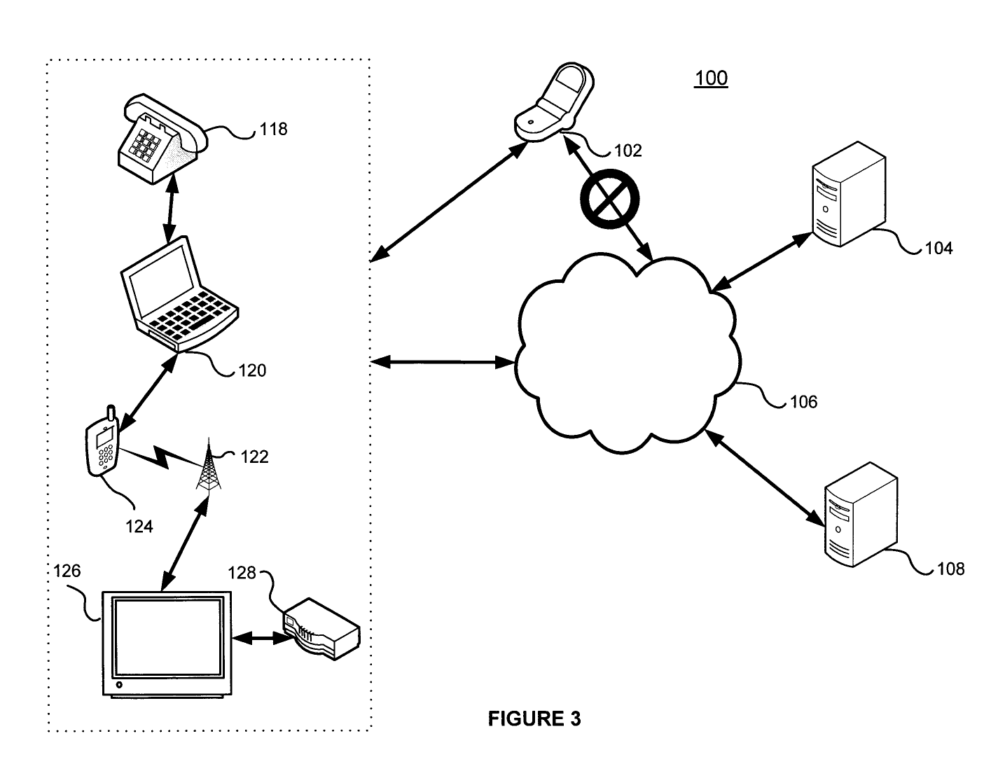

FIG. 3 illustrates a schematic diagram illustrating a system for relaying messages in the event that a mobile user device cannot establish a communication link with a communication network according to a particular embodiment. As illustrated in FIG. 3, the mobile user device 102 may not establish a communication link with the communication network 106 (e.g., system outage, severe weather, outside of service coverage range, or limited network infrastructure). However, a user associated with the mobile user device 102 may transmit one or more messages to one or more intended recipients via one or more ad hoc relay devices. The mobile user device 102 may notify the user that a communication link with the communication network 106 is currently not available. The mobile user device 102 may provide the user an option to transmit the one or more messages via an alternative method (e.g., relay the messages via ad hoc relay devices). The user may select whether to transmit the messages via the ad hoc relay devices. In another exemplary embodiment, the mobile user device 102 may automatically transmit the messages via the ad hoc relay devices based at least in part on a user selection or a service provider selection.

The mobile user device 102 may process the messages before transmitting the messages to one or more intended recipients. In an exemplary embodiment, the mobile user device 102 may compress the messages in order to reduce an amount of data transmitted and increase the transmission speed. In another exemplary embodiment, the mobile user device 102 may assign metadata (e.g., time stamp, priority level, hash, max-hop count) to the messages. In other exemplary embodiments, the mobile user device 102 may generate a hash file associated with the messages to determine whether the messages are delivered to the message delivery system 108 via the message relay system 104. For example, the mobile user device 102 may generate a hash file to create an index or record identifier for the messages associated with the hash file. In other instances, the mobile user device 102 may encrypt the messages and the metadata in order to provide a secure transmission of the messages.

The mobile user device 102 may search for one or more proximate ad hoc relay devices to relay the messages. For example, the ad hoc relay devices may include at least one of the telephone 118, the computer 120, the wireless device 124, the television 126, and the set-top box 128. The mobile user device 102 may transmit one or more ad hoc beacon signals to seek one or more proximate ad hoc relay devices and establish a communication link (e.g., Bluetooth, Wi-Fi or other radio frequency links). In the event that an ad hoc relay device (e.g., a wireless mobile user device 124) is located and the mobile user device 102 may establish a communication link with the ad hoc relay device, the mobile user device 102 may transmit the encrypted messages and metadata to the ad hoc relay device. In the event that the mobile user device 102 may establish a communication link with the communication network 106, the mobile user device 102 may transmit the encrypted messages and metadata to the message relay system 104 in order to determine whether the messages are delivered to the intended recipient.

The ad hoc relay devices may process the encrypted messages and metadata and store the encrypted messages and metadata. In an exemplary embodiment, the ad hoc relay devices may mark the hash file associated with the encrypted messages. For example, the ad hoc relay devices may mark the hash file that the encrypted messages have not been delivered to the message delivery system 108 via the message relay system 104. In another exemplary embodiment, the ad hoc relay devices may decrement the max-hop counter associated with the messages. For example, in the event that the max-hop counter is greater than 1, the ad hoc relay device may decrement the max-hop counter by 1 and transmit the encrypted message and metadata to another ad hoc relay device. In the event that the max-hop counter is equal to 1, the ad hoc relay device may decrement the max-hop counter by 1 and stop transmitting the encrypted message and metadata to another ad hoc relay device.

In an exemplary embodiment, some ad hoc relay devices may be communicatively coupled to the communication network 106 while other ad hoc relay devices may not be communicatively coupled to the communication network 106. In the event that an ad hoc relay device is communicatively coupled to the communication network 106, the ad hoc relay device may transmit the encrypted messages and metadata to the message relay system 104. However, in the event that an ad hoc relay device is not communicatively coupled to the communication network 106, the ad hoc relay device may continue to transmit the encrypted messages and metadata to another ad hoc relay device. Also, the ad hoc relay device may store the encrypted messages and metadata and the ad hoc relay device may move to an area where the ad hoc relay device may establish a communication link with the communication network 106. Once the ad hoc relay device establishes a communication link with the communication network 106, the ad hoc relay device may transfer the encrypted message and metadata to the message relay system 104 via the communication network 106.

The message relay system 104 may receive and process the encrypted messages and metadata. In an exemplary embodiment, the message relay system 104 may process the hash file in the metadata of an encrypted message. The message relay system 104 may identify the hash file in the meta data of an encrypted message and determine whether the encrypted message has been delivered. For example, the message relay system 104 may include a database of hash files of delivered messages. The message relay system 104 may search the database of hash files to determine whether the received encrypted message has been delivered. In the event that the hash file of a received encrypted message matches a hash file stored in the hash files database, the message relay system 104 may delete or discard the received encrypted message. The message relay system 104 may also transmit a “Delivered” status message signal to an ad hoc relay device or a mobile user device 102 in order to notify the ad hoc relay device or the mobile user device 102 that the encrypted message has been delivered to the intended recipient. The “Delivered” status message signal may have a lower priority level than the encrypted message and may be transmitted at a later time (e.g., when more bandwidth is available, or at the end of an operation or function).

In the event that the hash file of a received encrypted message does not match a hash file stored in the hash files database of the message relay system 104 (e.g., a new and undelivered encrypted message), the message relay system 104 may process the received encrypted message and record the hash file in the hash files database. In an exemplary embodiment, the message relay system 104 may decrypt the received encrypted message. For example, the message relay system 104 may decrypt the received encrypted message via a private key. In another exemplary embodiment, the message relay system 104 may format the message for delivery to the intended recipient. For example, the message relay system 104 may add a notification message to the received message. The notification message may inform the intended recipient that the sender may not be available to receive a reply. The notification message may also notify the intended recipient about information associated with the received message including, time stamps, location of the sender, user identification and information, mobile user device identification information, priority level, or other information or data associated with the messages.

Upon processing the received messages, the message relay system 104 may transfer the processed message to the message delivery system 108. The message delivery system 108 may deliver the message from the message relay system 104 to the intended recipient. The message relay system 104 may store a hash file associated with the received message in the hash files database for a predetermined period of time. The message relay system 104 may transfer a “Delivered” status message signal to an ad hoc relay device or a mobile user device 102 in order to notify the ad hoc relay device or the mobile user device 102 that the message has been delivered to the intended recipient. The ad hoc relay device or the mobile user device 102 may process the hash file associated with the messages and delete or discard the messages. For example, the ad hoc relay device or the mobile user device 102 may denote in the hash file that the message has been delivered to the intended recipient. The ad hoc relay device or the mobile user device 102 may store the hash file for a predetermined period of time in order to eliminate transmitting the message twice.

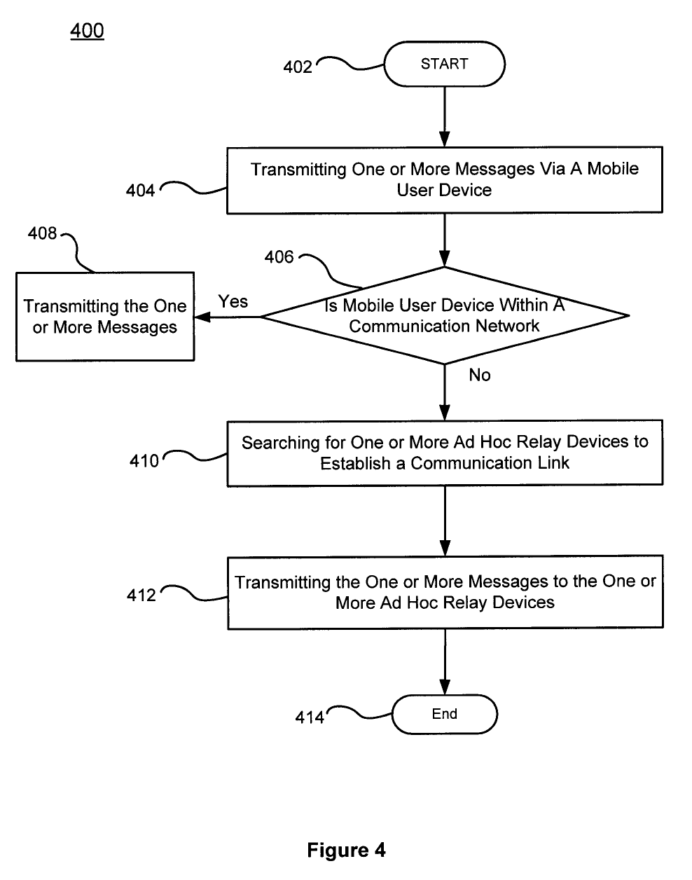

FIG. 4 is a flowchart illustrating the functionality for relaying messages associated with a mobile user device according to a particular embodiment. This exemplary method 400 may be provided by way of example, as there are a variety of ways to carry out the method. The method 400 shown in FIG. 4 can be executed or otherwise performed by one or a combination of various systems. The method 400 is described below may be carried out by the system and network shown in FIGS. 1-2, by way of example, and various elements of the system and network are referenced in explaining the example method of FIG. 4. Each block shown in FIG. 4 represents one or more processes, methods or subroutines carried out in exemplary method 400. Referring to FIG. 4, exemplary method 400 may begin at block 402.

At block 402, the method 400 for relaying messages may begin.

At block 404, one or more messages may be transmitted via a mobile user device 102. A user associated with the mobile user device 102 may transmit one or more messages to one or more intended recipients. For example, the mobile user device 102 may process the messages before transmitting the messages to one or more intended recipients. In an exemplary embodiment, the mobile user device 102 may compress the messages in order to reduce an amount of data transmitted and increase the transmission speed. In another exemplary embodiment, the mobile user device 102 may assign metadata (e.g., time stamp, priority level, hash file, max-hop count) to the messages. In other exemplary embodiments, the mobile user device 102 may generate a hash file associated with the messages to determine whether the messages are delivered to the message delivery system 108 via the message relay system 104. For example, the mobile user device 102 may generate a hash file to indicate that the messages have not been delivered. In other instances, the mobile user device 102 may encrypt the messages and the metadata in order to provide a secure transmission of the messages. After transmitting one or more messages via the mobile user device 102, the method 400 may proceed to block 404.

At block 404, the mobile user device 102 may determine whether a communication link can be established with a communication network 106. In the event that the mobile user device 102 may establish a communication link with the communication network 106, the method 400 may proceed to block 408. In the event that the mobile user device 102 may not establish a communication link with the communication network 106, the method 400 may proceed to block 410.

At block 408, the one or more messages may be transmitted to a message delivery system 108. For example, the mobile user device 102 may transmit the one or more messages to the message delivery system 108 via the communication network 106. The message delivery system 108 may process the one or more messages and deliver the one or more messages to the intended recipient.

In the event that the mobile user device 102 does not have a communication link with the communication network 106, the mobile user device 102 may notify the user that a communication link with the communication network 106 is currently not available. The mobile user device 102 may provide the user an option to transmit the one or more messages via an alternative method (e.g., relay the messages via ad hoc relay devices). The user may select whether to transmit the messages via the ad hoc relay devices. In another exemplary embodiment, the mobile user device 102 may automatically transmit the messages via the ad hoc relay devices based at least in part on a user selection or a service provider selection.

At block 410, the mobile user device 102 may search for one or more proximate ad hoc relay devices to establish a communication link in order to relay the messages. For example, the ad hoc relay devices may include at least one of the telephone 118, the computer 120, the wireless device 124, the television 126, and the set-top box 128. The mobile user device 102 may transmit one or more ad hoc beacon signals to seek one or more proximate ad hoc relay devices and establish a communication link (e.g., Bluetooth, Wi-Fi or other radio frequency links). After searching for one or more ad hoc relay devices to establish a communication link, the method 400 may proceed to block 412.

At block 412, the mobile user device 102 may transmit the encrypted messages and metadata to the ad hoc relay device. For example, the mobile user device 102 may establish a communication link with an ad hoc relay device (e.g., a wireless mobile user device 124), the mobile user device 102 may transmit the encrypted messages and metadata to the ad hoc relay device. The ad hoc relay device may receive the encrypted messages and metadata from the mobile user device 102. After transmitting the one or more messages to the one or more ad hoc relay devices, the method 400 may proceed to block 414.

At block 414, the method 400 may end.

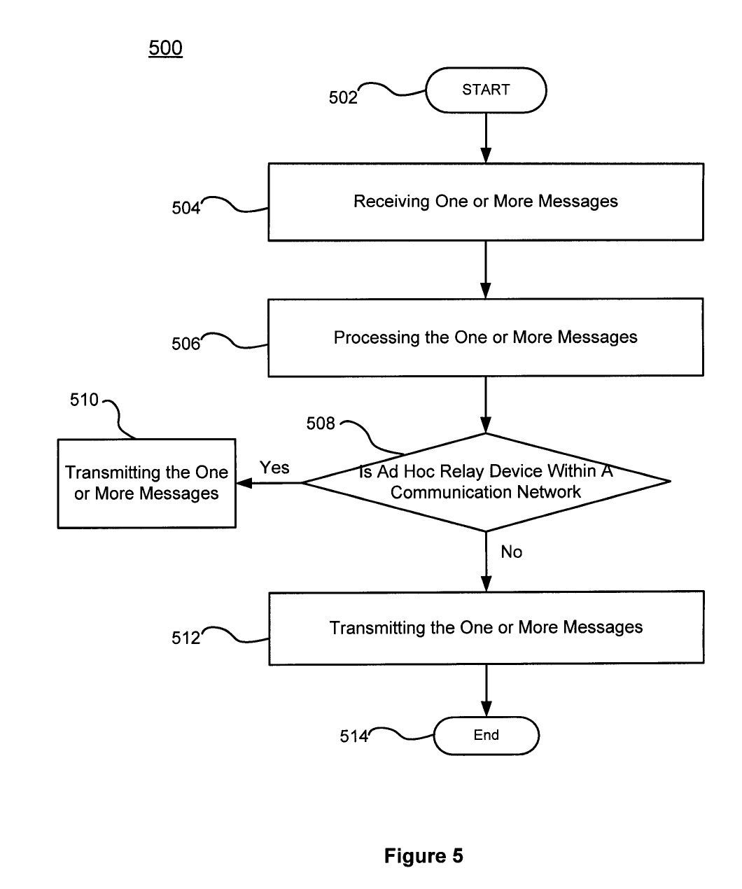

FIG. 5 is a flowchart illustrating the functionality for relaying messages associated with an ad hoc relay device according to a particular embodiment. This exemplary method 500 may be provided by way of example, as there are a variety of ways to carry out the method. The method 500 shown in FIG. 5 can be executed or otherwise performed by one or a combination of various systems. The method 500 is described below may be carried out by the system and network shown in FIGS. 1-2, by way of example, and various elements of the system and network are referenced in explaining the example method of FIG. 5. Each block shown in FIG. 5 represents one or more processes, methods or subroutines carried out in exemplary method 500. Referring to FIG. 5, exemplary method 500 may begin at block 502.

At block 502, the method 500 for relaying messages may begin.

At block 504, an ad hoc relay device may receive an encrypted message. For example, the ad hoc relay device may include a telephone 118, a computer 120, a transmitter/receiver 122, a wireless mobile user device 124, a television 126, or a set-top box 128. The ad hoc relay device may receive an encrypted message from the mobile user device 102 or another ad hoc relay device. The encrypted message may include metadata (e.g., time stamp, priority level, hash file, max-hop count) associated with the encrypted message. After receiving the encrypted message, the method 500 may proceed to block 506.

At block 506, the ad hoc relay device may process the encrypted message. The ad hoc relay device may process the encrypted messages and metadata and store the encrypted messages and metadata. In an exemplary embodiment, the ad hoc relay device may process the max-hop counter in the metadata of the encrypted messages in order to prevent repeated transmission of the encrypted messages. For example, the ad hoc relay device may decrement the max-hop counter each time the messages are relayed to another ad hoc relay device (e.g., the telephone 118, the computer 120, the transmitter/receiver 122, the wireless mobile user device 124, the television 126, or the set-top box 128). The encrypted messages may be relayed via one or more ad hoc relay devices until the max-hop counter reaches zero.

In another exemplary embodiment, the ad hoc relay device may process the hash file in the metadata of the encrypted messages. For example, the ad hoc relay device may mark the hash file associated with the encrypted messages. The ad hoc relay device may mark the hash file to indicate that the encrypted messages have not been delivered to the message delivery system 108 via the message relay system 104. Also, the ad hoc relay device may mark the hash file to indicate that the encrypted messages have been delivered to the message delivery system 108 via the message relay system 104. For example, in the event that the max-hop counter is greater than 1, the ad hoc relay device may decrement the max-hop counter by 1 and transmit the encrypted message and metadata to another ad hoc relay device. In the event that the max-hop counter is equal to 1, the ad hoc relay device may decrement the max-hop counter by 1 and stop transmitting the encrypted message and metadata to another ad hoc relay device. After processing the encrypted message, the method 500 may proceed to block 508.

At block 508, the ad hoc relay device may determine whether a communication link can be established with a communication network 106. In the event that the ad hoc relay device may establish a communication link with the communication network 106, the method 500 may proceed to block 510. In the event that the ad hoc relay device may not establish a communication link with the communication network 106, the method 500 may proceed to block 512.

At block 510, the one or more messages may be transmitted to a message delivery system 108. For example, the ad hoc relay device may transmit the encrypted message to the message relay system 104 via the communication network 106. The message relay system 104 may process the one or more messages and deliver the encrypted message to the message delivery system 108.

At block 512, in the event that the mobile user device 102 does not have a communication link with the communication network 106, the ad hoc relay device may transmit the encrypted message to the message relay system 104 via other ad hoc relay devices. Also, the ad hoc relay device may relocate to an area within a coverage range of the communication network 106 to transmit the encrypted message to the message relay system 104. After transmitting the encrypted message, the method 500 may proceed to block 514.

At block 514, the method 500 may end.

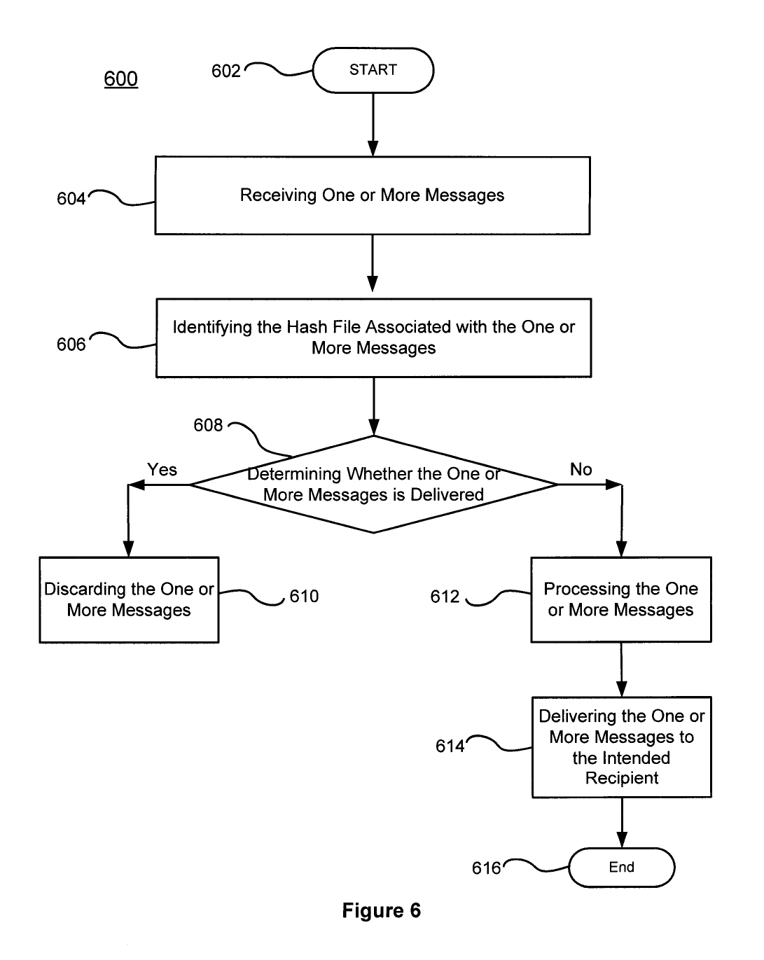

FIG. 6 is a flowchart illustrating the functionality for relaying messages associated with a message relay system according to a particular embodiment. This exemplary method 600 may be provided by way of example, as there are a variety of ways to carry out the method. The method 600 shown in FIG. 6 can be executed or otherwise performed by one or a combination of various systems. The method 600 is described below may be carried out by the system and network shown in FIGS. 1-2, by way of example, and various elements of the system and network are referenced in explaining the example method of FIG. 6. Each block shown in FIG. 6 represents one or more processes, methods or subroutines carried out in exemplary method 600. Referring to FIG. 6, exemplary method 600 may begin at block 602.

At block 602, the method 600 for relaying messages may begin.

At block 604, the message relay system 104 may receive an encrypted message. For example, the message relay system 104 may receive an encrypted message from one or more ad hoc relay devices. The encrypted message may include metadata (e.g., time stamp, priority level, hash file, max-hop count) associated with the encrypted message. After receiving the encrypted message, the method 600 may proceed to block 606.

At block 606, the message relay system 104 may identify a hash file associated with the encrypted message. The message relay system 104 may identify the hash file in the metadata of an encrypted message. For example, the message relay system 104 may identify the hash file to determine an authenticity of the encrypted message. After, identifying a hash file associated with the encrypted message, the method 600 may proceed to block 608.

At block 608, the message relay system 104 may determine whether the encrypted message is delivered. For example, the message relay system 104 may include a database of hash files of delivered messages. The message relay system 104 may search the database of hash files to determine whether the received encrypted message has been delivered. In the event that the hash file of a received encrypted message matches a hash file stored in the hash files database, the method 600 may proceed to block 610. In the event that the hash file of a received encrypted message does not match a hash file stored in the hash files database, the method 600 may proceed to block 612.

At block 610, the message relay system 104 may delete or discard the received encrypted message. For example, in the event that the encrypted message has been delivered, the message relay system 104 may transmit a “Delivered” status message signal to an ad hoc relay device or a mobile user device 102 in order to notify the ad hoc relay device or the mobile user device 102 that the encrypted message has been delivered to the intended recipient via the message delivery system 108. Also, the “Delivered” status message signal may have a lower priority level than the encrypted message and may be transmitted at a later time (e.g., when more bandwidth is available, end of an operation or function). Upon reception of the “Delivered” status message signal, the ad hoc relay device may delete or discard the encrypted message. In another exemplary embodiment, the ad hoc relay device may maintain the hash file to identify that the encrypted message has been delivered.

At block 612, the message relay system 104 may process the received encrypted message and record the hash file in the hash files database. In an exemplary embodiment, the message relay system 104 may decrypt the received encrypted message. For example, the message relay system 104 may decrypt the received encrypted message via a private key. In another exemplary embodiment, the message relay system 104 may format the message for delivery to the intended recipient. For example, the message relay system 104 may add a notification message to the received message. The notification message may inform the intended recipient that the sender may not be available to receive a reply. The notification message may also notify the intended recipient about information associated with the received message including, time stamps, location of the sender, user identification and information, mobile user device identification information, priority level, or other information or data associated with the messages. After processing the encrypted messages by the message relay system 104, the method 600 may proceed to block 614.

At block 614, the message relay system 104 may deliver the one or more messages to an intended recipient. For example, the message relay system 104 may transfer the processed message to the message delivery system 108. The message delivery system 108 may deliver the message from the message relay system 104 to the intended recipient. The message relay system 104 may store a hash file associated with the received message in the hash files database for a predetermined period of time. The message relay system 104 may transfer a “Delivered” status message signal to an ad hoc relay device or a mobile user device 102 in order to notify the ad hoc relay device or the mobile user device 102 that the message has been delivered to the intended recipient. The ad hoc relay device or the mobile user device 102 may process the hash file associated with the messages and delete or discard the messages. For example, the ad hoc relay device or the mobile user device 102 may denote in the hash file that the message has been delivered to the intended recipient. The ad hoc relay device or the mobile user device 102 may store the hash file for a predetermined period of time in order to eliminate transmitting the message twice. After delivering the one or more messages to the intended recipient, the method 600 may proceed to block 616.

At block 616, the method 600 may end.

The description above describes mobile devices, a message relay system, a message delivery system, storage devices, various communication networks, and for coupling a user via the communication network, some of which are explicitly depicted, others of which are not. As used herein, the term “module” may be understood to refer to stored computer readable executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, etc.) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A method, comprising:
receiving a request from a user to transmit a message to an intended recipient;
processing the message for transmission, wherein processing the message comprises assigning metadata to the message; and
transmitting the message with the metadata to the intended recipient, wherein transmitting the message with metadata comprises 1) detecting that a communication link cannot be established with a communication network, and 2) searching for at least one proximate ad hoc relay device.

2. The method according to claim 1, wherein processing the message further comprises compressing the message in order to reduce an amount of data transmitted and increase a transmission speed of the message.

3. The method according to claim 1, further comprises generating a hash file associated with the message in order to determine whether the message is delivered to the intended recipient.

4. The method according to claim 1, wherein processing the message further comprises encrypting the message with the metadata in order to provide a secure transmission.

5. The method according to claim 1, further comprises determining whether the communication link can be established with the communication network.

6. The method according to claim 1, wherein processing the message further comprises assigning a max-hop count to the message in order to indicate a number of times the message is transmitted.

7. The method according to claim 1, wherein the metadata includes at least one of time stamps, location, the user identification and information, the intended recipient identification and information, a hash file, a max-hop counter and a priority level.

8. The method according to claim 1, wherein searching for at least one proximate ad hoc relay device comprises transmitting at least one ad hoc beacon signal to seek the at least one proximate ad hoc relay device to establish the communication link.

9. The method according to claim 8, wherein the communication link includes at least one of a Bluetooth link and a Wi-Fi link.

10. A computer readable storage media comprising code to perform the method of claim 1.

11. A method, comprising:
receiving at least one encrypted message having metadata from at least one mobile user device destined for an intended recipient;
processing the at least one encrypted message; and
transmitting the at least one encrypted message to a message relay system when a communication link is established with a communication network.

12. The method according to claim 11, further comprises transmitting the at least one encrypted message to another ad hoc relay device in the event that the communication link cannot be established with the communication network.

13. The method according to claim 11, wherein transmitting the at least one encrypted message to a message relay system in the event that a communication link is established with a communication network comprises relocating to establish the communication link with the communication network.

14. The method according to claim 11, wherein processing the at least one encrypted message comprises updating a hash file associated with the metadata of the at least one encrypted message to indicate in the hash file that the at least one encrypted message have not been delivered to the message relay system.

15. The method according to claim 11, wherein processing the at least one encrypted message comprises decrementing a max-hop counter associated with the metadata of the at least one encrypted message.

16. A method, comprising:
receiving at least one encrypted message having metadata from an ad hoc relay agent;
identifying a hash file associated with the metadata of the at least one encrypted message; and
transmitting the at least one encrypted message to a message delivery system based at least in part on the hash file.

17. The method according to claim 16, further comprises searching a hash file database to identify the hash file associated with the metadata of the at least one encrypted message to determine whether the at least one encrypted message have been delivered based at least in part on the hash file.

18. The method according to claim 16, wherein processing the at least one encrypted message comprises decrypt the at least one encrypted message via a key.

19. The method according to claim 16, further comprises transmitting a status message signal to notify the ad hoc relay device that the at least one encrypted message have been delivered to an intended recipient.

20. The system, comprising:
a presentation module configured to receive a request from a user to transmit a message to an intended recipient;
a processing module configured to process the message for transmission, wherein processing the message comprises assigning metadata to the message; and
an ad hoc relay agent module configured to transmit the message with the metadata to the intended recipient, wherein transmitting the message with metadata comprises 1) detecting that a communication link cannot be established with a communication network, and 2) searching for at least one proximate ad hoc relay device.

21. The system according to claim 20, further comprises a database module configured to store the message.

22. The system according to claim 20, further comprises an encryption module configured to encrypt the message.
